(19) United States
(12) Patent Application Publication
(10) Pub. No.: US 2002/0029156 A1
(43) Pub. Date: Mar. 7, 2002

(54) Method for anonymizing patient identity and clinical samples

(75) Inventor: David G. O'Dowd, Boston, MA (US)

Correspondence Address: David E. Brook, Esq., HAMILTON, BROOK, SMITH & REYNOLDS, P.C., Two Militia Drive, Lexington, MA, 02421-4799, US

(73) Assignee: Genomics Collaborative, Inc., Cambridge, MA (US)

(21) Appl. No.: 09/758,912

(22) Filed: Jan. 11, 2001

Related U.S. Application Data
(60) Provisional application No. 60/230,382, filed on Sep. 6, 2000.

(51) Int. Cl. G06F 17/60

(52) U.S. Cl. 705/3

(57) ABSTRACT

This invention relates to methods for anonymizing clinical samples for use in a variety of research and development activities.

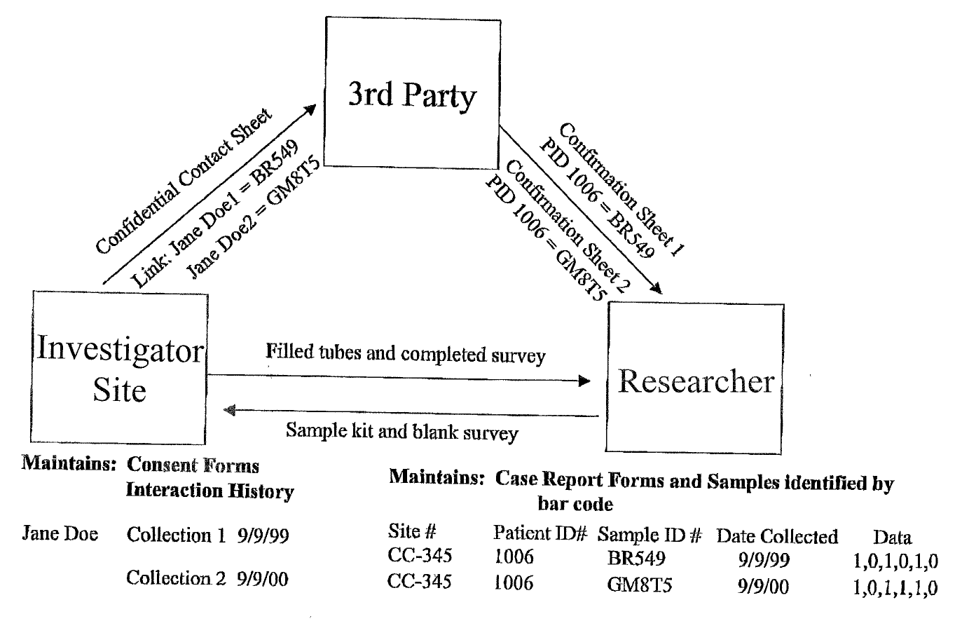

### RELATED APPLICATION

This application claims the benefit of U.S. Provisional Application No. 60/230,382, filed Sep. 6, 2000, the entire teachings of which are incorporated herein by reference.

### BACKGROUND OF THE INVENTION

In pharmaceutical and biotechnology research and development, there is a critical need for the collection of well-characterized genetic material from various sources. The genetic material is frequently in the form of biological samples taken from various persons receiving medical care. Confidential data regarding the person's identity and medical information is often also collected.

The genetic material and associated medical information is of great use to medical researchers. However, it is essential to protect the confidentiality of the subject's personal information from duplication, theft or other misappropriation by maintaining the information in a confidential medical record that is inaccessible to the researcher. Typically, the researcher receives anonymous samples from the collector of those samples, who is often the patient's primary care physician. The sample collector generally maintains the only knowledge of the association of the sample with the patient subject's identity. However, from time to time, samples are sent inadvertently to researchers with the associated subject patient's name. Additional challenges to the protection of patient privacy arise where researchers need, sometimes years later, to follow up with selected subjects in order to further their studies or validate their conclusions. Having the sample collector maintain the link between a patient subject and a particular sample is impractical for long-term follow up studies. Accordingly, there is a need for a way of collecting samples and their associated patient information, and allowing long-term followup regarding these patients and their samples, without requiring the collector of the samples to take on the responsibility of maintaining (over many years), the link between the subject, the samples, and the associated information.

### SUMMARY OF THE INVENTION

The present invention relates, in part, to methods for anonymizing clinical samples collected for use in a variety of research and development activities. The method of the invention is useful in providing samples without personal identifiers to researchers for use in snap-shot studies, and is especially useful in longitudinal studies.

In one embodiment, the method for anonymizing samples for use in research and development activities comprises (a) collecting one or more samples from a subject by an investigator site, (b) providing a sample to a researcher by the investigator site, where the sample is associated with a first code, (c) providing personal information to a third party by the investigator site, where the personal information is sufficient to link the subject with the one or more samples, and (d) providing a second code to the researcher by the third party. The method can also comprise the additional step of the destruction of the personal information. The samples can be used in a longitudinal study.

In another embodiment, the method for anonymizing samples for use in research and development activities comprises (a) collecting from a subject by an investigator site a sample, and sample information, (b) providing to a third party by the investigator site the sample information, and personal information sufficient to link the subject with the sample and the sample information, (c) providing the sample to a researcher by the investigator site, where the sample is associated with a first code, and (d) providing to the researcher by the third party the sample information, where the sample information is associated with a second code. The method can also comprise the additional steps of (e) providing to the third party by the researcher the first code, and a request for one or more samples of the subject associated with the first code, and (f) taking a sample from the subject by the third party, where the sample is associated with the first code of (e), and providing the sample to the researcher. The method can also comprise the additional steps of (e) providing to the third party by the researcher the second code, and a request for one or more samples of the subject associated with the second code, and (f) taking a sample from the subject associated with the second code of (e), where the sample is taken by the third party and provided to the researcher.

In an additional embodiment, the method for anonymizing samples for use in research and development activities comprises (a) providing a request for a sample by a researcher to a third party, (b) soliciting the sample from one or more investigator sites where the soliciting is done by the third party, (c) collecting of a sample, sample information, and personal information by the investigator sites, (d) submitting the sample, sample information and personal information by the investigator site to the third party, where the sample, sample information and personal information are coded with a first code, (e) associating a second code with the sample, sample information and personal information, where the associating is done by the third party, (f) submissing the sample and sample information to the researcher by the third party, and (g) storing of the personal information by the third party. The first code can be provided by the researcher, or by the third party.

### BRIEF DESCRIPTION OF THE DRAWING

The FIGURE is a diagram illustrating the method of the invention.

### DETAILED DESCRIPTION OF THE INVENTION

The present invention relates, in part, to newly-developed methods for anonymizing clinical samples collected for use in a variety of research and development activities. The method of the invention is useful in providing samples without personal identifiers to researchers conducting snap-shot studies and is especially useful in conducting longitudinal studies. The method is particularly useful in study protocols where follow-up on particular patient samples is desirable. “Snap-shot studies” are studies of samples where the research protocol proposes that samples be taken from patient subjects only once. “Patient subjects” or “subjects” are human subjects from which samples are taken. “Longitudinal studies” are studies of samples where the research protocol proposes that samples be taken from some or all of the subjects in the study more than once, and at different points in time. Researchers (e.g., university, government, or corporate scientists) generally obtain genetic samples from investigator sites (e.g., collectors of the samples). By “investigator sites” is meant physicians, medical facilities, doctor's offices and research centers, or any site where samples are collected for research and development. The samples are typically biological samples, e.g., sources of human genetic material, including but not limited to, bodily fluids (e.g., blood, serum, plasma, or tissue), or tissue (e.g., muscle, organ biopsies, tumor tissue). Preferably, the sample is blood, tissue biopsy or tumor biopsy material. Generally, the samples are biological materials taken from a patient diagnosed with a medical disease or condition, or suspected of having a medical disease or condition. Alternatively, the samples may be from subjects who are known to not have the medical disease or condition, i.e., the subjects are control subjects.

Over time, it is not uncommon for researchers to require additional genetic material from one or more of the patient subjects. Because these requests may be made years after the initial collector has taken the sample from the patient subject, fulfilling such requests effectively requires the collector to keep track of the patient subjects and their associated personal information (e.g., contact information, such as address, telephone numbers, etc.). Such long-term tracking of subjects may be cumbersome or impossible for the collector, and there is therefore a need to provide a third-party link, who is neither a collector or a researcher, between a patient subject and a collected sample. This third party would be responsible for maintaining the confidentiality of the patient subject's personal information, and would undertake, or arrange for, further collections of samples from the patient subjects. In this way, the collector may obtain samples from subjects with no long-term obligations, and the researcher has the opportunity to follow up with specific subjects indirectly to obtain additional samples from specific patient subjects. The method of the present invention provides an impermeable barrier between researchers and subjects.

In the method of the present invention, a third party is identified or created, and serves as a barrier to prevent the release of personal information regarding a subject who has donated samples for research. “Third party” means any third party other than the researcher or investigator site, where the third party is capable of providing third-party records storage and escrow protection by storing, retaining and allowing limited access to confidential proprietary records and related materials. Escrow agents are known to those skilled in the art and can be used. Preferably the third party has experience in escrowing medical records.

In one embodiment, an investigator site collects one or more samples from a subject, associates the samples with a first code, and then send the samples, each with its associated first code, to a researcher. The investigator site then sends to the third party information that is sufficient to link the subject with the samples, e.g., the link can be a social security number, or contact information (e.g., name and address, telephone number, etc.). The third party then sends the researcher a second code, where the second code is understood to serve as a link between the samples and the subject, should the researcher ever require additional samples or medical information from that subject. The second code should generally be insufficient for enabling the researcher to locate or contact the subject, but rather, serves as a “key”, enabling the researcher to contact the third party, who can have the subject contacted. If the researcher requires additional samples or medical information from a subject, the researcher will make such a request to the third party, providing the second code with the request, so that the third party can have the subject contacted.

By “personal information”, or “personal information sufficient to link the subject with the one or more samples”, is meant information that provides a way of discerning the identity of the subject that donated a particular sample, e.g., the subject's name, address, telephone number, social security number, etc. Such personal information can also be an identification code internal to the investigator site, e.g., a patient identification number or an account number. The personal information can be recorded on a Confidential Contact Sheet (CCS). “CCS”, or “Confidential Contact Sheet” means a body of pertinent, confidential personal data regarding the subject's identity and background sufficient to line a patient subject with a sample and also with information regarding the subject. Typically and preferably, this information includes but is not limited to, the patient's name, address and birth date, sample collection date, information on whether or not the patient has consented to longitudinal follow-up, and a unique identifier (e.g., social security number, patient's mother's maiden name).

By “sample information” is meant information of interest to the researcher using the sample. The sample information can be recorded on a Sample Information Sheet (SIS). The sample information will include information about the sample itself (e.g., type of tissue, manner in which the sample was taken, etc.), and will generally also include the medical condition and the medical history of the subject from which the sample was taken (e.g., “44-year-old male with lung cancer”). The sample information can also include the medical history of the subject's relatives, if pertinent. For some types of studies, the sample information will also include “lifestyle” information, e.g., information on smoking, alcohol intake, diet, exercise habits, etc. The sample information can also include environmental information, e.g., proximity of the subject's residence to particular industries or types of infrastructure (e.g., distance from the subject's home to a factory, dump, incinerator, microwave tower, power lines, etc.). The sample information should not enable one to deduce the subject's identity or allow one to contact the subject directly.

Because the invention seeks to anonymize the link between samples and their donors, great care must be taken by the third party in choosing the type or form of the second code that is sent to the researcher. Ideally, the third party should generate an entirely new second code for the subject, rather than generating a second code that is a function of an identifier used by an investigator site. For instance, if a third party receives personal information from the investigator site identifying a subject as a patient at a hospital, the third party should generate an entirely new second code that is independent of the patient's hospital ID number. Researchers are frequently medical personnel having positions in hospitals, and if a patient's ID number were known, it could be a relatively easy matter for some researchers to deduce the identity of subjects in a study. The third party should therefore generate second codes de novo, rather than codes that are based in some way upon the information provided by the investigator site.

By “associated with a code” is meant that the sample information and/or a sample has attached to it, printed on it, or is labeled with, a code, e.g., a bar code, or other type of identifier. That is, the identifier can be a bar code, or an alphanumeric or symbolic string or other form of identifier, and is associated with the information or sample so that it serves to identify the information or sample. However, the code should not allow one to discern the identity of a subject, e.g., the “code” should not be the subject's same or social security number. The first and second codes may be of different types, e.g., the first code can be a bar code, while the second code can be an alphanumeric code.

The method can include the additional step where the investigator site later destroys the personal and sample information that was sent to the third party by the investigator site. Preferably, the destruction of the information is done after a period of time sufficient for resolving queries, discrepancies, misunderstandings, etc. The length of the period of time should be specified ahead of time, e.g., in a contract between the investigator site and the third party. The researcher should also know that the information will be destroyed, and the length of the period of time before this is done. That is, the researcher must know the period of time within which queries must be made regarding the samples and the sample information.

The researcher and third party can enter into an agreement detailing the particulars of their relationship. That is, the agreement can describe how many samples the researcher needs, how the samples will be coded between the researcher and the investigator site, and what information will be collected on the Confidential Contact Sheet (CCS) by the third party.

The researcher can enroll investigator sites into its investigation protocol in accordance with its standard practices. Protocols can be used for any purpose that involves the study of samples, including but not limited to, treatment protocols, such as the study of a new drug, or pure research protocols where no treatment is given to the patient and samples are only procured separately or in connection with a medical procedure that the patient is undergoing. As part of this registration process, the researcher will provide the investigator site with particulars of how to code (without the inclusion of patient identifiers) the samples that are to be sent to the researcher, and how to escrow the personal information and the CCS with the third party.

The researcher will inform the third party of all investigator sites it is currently conducting business with, and with which it desires escrow, by providing the third party of a listing of each investigator site's location and pertinent and contact details. The third party shall preferably maintain this listing as information confidential to the researcher. The researcher will generally provide the third party with updates of this listing at periodic intervals.

Investigator sites affiliated with the researcher will deliver to the third party completed CCSs concurrent with the delivery of samples to the researcher or as the CCSs become available. The CCS submission process is preferably as shown below:

1. The investigator site reviews the CCS to ensure that it is completed properly and that all fields are completed as the samples are collected from the patient subjects. SISs are completed concurrently for the samples.

2. The investigator site submits the samples and the SISs to the researcher.

3. The investigator site will then prepare a transmittal form for the third party, listing the total quantity of CCS files being sent by the investigator site. “Files” as used herein, means information in paper form, or magnetic or other electronic medium for recording information.

4. The CCS files will be transmitted to the third party, preferably with a qualified parcel carrier that provides for the tracking of packages, or by an electronic method that ensures reasonable privacy (e.g., encryption).

The third party preferably acknowledges receipt to the researcher and optionally the transmitting investigator site with the physical number of CCS files taken into secure storage by third party. The third party will generate at least one third party CCS identifier number (“CIN”) code, preferably a bar code, which will correspond to a sample identification code, preferably a bar code. The use of bar codes are well known to those of skill in the art. At this point in the escrow method, the patient information in the CCS linked to a particular sample has been coded by the investigator site at the direction of the researcher and coded again by the third party.

The third party may also assign each subject another code such as a unique subject ID number that will link various samples to an individual subject. The unique subject ID number (e.g., “PIED”) will be generated by third party and is preferably a random number that is unrelated to any information contained on the CCS form. Upon the third party's completion of indexing any batch of CCS data into its private database, the third party will provide to the researcher an electronic report listing the CIN, PID, sample bar code, sample Collection Date and a “Yes/No” qualifier as to whether the subject agrees to either longitudinal and/or subsequent follow up.

The third party therefore acts as custodian of the CCS until the escrow is terminated pursuant to a relevant agreement. The third party establishes, under its control, a secure storage site for the purpose of storing the CCS. After a period of time sufficient to resolve any queries by the researcher, e.g., 90 days, the investigor site can destroy the CCS in its possession.

Once the CCSs are deposited with the third party, the researcher, the investigator sites or any other party will not have the right to withdraw any CCS from safe storage except as described below.

In longitudinal studies, researchers may request subsequent samples from specific subjects who have authorized follow up on their CCS. In order to solicit further samples from an individual subject, the researcher will provide the third party with a list of CIN's and PID's and the associated investigator site, which may be kept as ID numbers. Concurrent with this, the researcher will provide the investigator sites with additional sample kits and new sample bar codes for collection of follow up samples. The third party will provide the investigator site with a physical or electronic copy of the information contained on the original CCS for the investigator site's follow up with the subject.

Once the third party delivers the pertinent CCS data, it is the investigator site's sole option to follow up with the identified subjects and submit an updated sample to the researcher and an updated CCS to the third party for the subsequent sample. The third party shall not initiate contact with a subject. Each subsequent sample's CCS shall be handled as a separate record for storage and tracking purposes with the third party.

The researcher and/or the subject of any CCS preferably shall have the right to request the destruction of any given CCS records.

### EXAMPLES

### Example 1.

In this example, a third party will be responsible for maintaining the link between the researcher's bar code on a sample and the identity of the patient subject. Neither the researcher nor any other party is allowed access to this link. The researcher can request, for itself or on the part of another party, additional information about a specific patient subject or may request duplicate information from a specific patient subject to validate the researcher's particular study and data.

Initial Collection.

1. The researcher sends out kits for the collection of human samples and case report forms (CRFs) relating to the collection of the sample to participating investigator sites. Along with the kit, the researcher sends out a coding mechanism, generally bar code labels, for the sample collection devices and the CRFs, so that the samples and CRFs return to the researcher coded without patient identifiers.

2. The investigator site identifies patient subjects, completes investigational review board approval (if required) informed consent documentation, confidential contact sheet (CCS), case report form (CRF) and collection of the sample.

3. The investigator site retains a copy of the informed consent documentation, and records the name and date of sample collection for the individual (patient subject) who has donated the sample, retaining this information in his/her office, not in the donor's medical record.

4. The investigator site sends the completed CRF and sample kit, identified by the researcher's bar codes, to the researcher.

5. The investigator site sends the CCS connecting the researcher bar code number and patient subject name to the third party.

6. The third party sends the researcher the sample ID number (e.g., BR 549) and the link (e.g., PID 1006).

Re-contacting Subjects for Additional Data And/or Samples.

7. The researcher supplies a list of patient ID numbers requiring follow up to the third party.

8. The researcher supplies new CRFs and kits to the investigator sites that originally collected the previous samples.

9. The third party will contact the investigator sites indicating the patient subjects requiring follow up.

10. The investigator site sends completed CRFs (with an additional sample if required) to the researcher using the bar code provided by the researcher.

11. The investigator site sends the link between the new sample code and subject name to the third party using a CCF.

12. The third party will send the link (e.g., BID 1006) between new sample ID number (e.g., GM 8T5) and the previous sample ID (e.g., BR 549) number to the researcher.

13. The researcher links new CRFs to existing CRFs using the link.

### Example 2.

In this example, there is no link between the researcher and the investigator site, that is, the researcher does not contact the investigator site in order the receive samples. In such a case, all materials pass through the third party.

1. The researcher contacts the third party, requesting samples of a particular type, or from subjects that meet a specified set of criteria. Preferably, the researcher provides the third party with sample collection kits which are bar coded with a first code, and additional labels for each bar code. For each different first code, the additional labels are then placed on a CCS and an SIS. That is, for a given first code, there is a single sample collection kit, CCS and SIS, all sharing a single first code.

2. The third party contacts investigator sites, and solicits the submission of samples and related personal information, and sample information. Preferably, the third party provides the investigator site with the sample collection kits (preferably provided by the researcher), CCSs and SISs, all coded with first codes.

3. The investigator site identifies patient subjects, completes investigational review board approval (if required) informed consent documentation, CCS and SIS and collection of the sample.

4. For each subject from whom a sample is collected, the investigator site sends the sample, the completed CCS and SIS, all identified by a single first code, to the third party.

5. The third party then generates a second code for each sample and its associated CCS and SIS. The CCSs are stored.

6. The third party then sends the samples and SISs to the researcher, along with a list of the first codes (generated by the researcher), and the second code assigned to each first code. The second code serves as a link or key, allowing the researcher to request additional information or samples at a later date.

7. In the event that a researcher should make such a request, the researcher provides to the third party the second code, and a request for materials (samples or sample information) associated with that code.

8. The third party then uses the second code to look up the subject associated with that code, and contacts the subject via the investigator site, or uses a new investigator site to renew the contact with the subject. In some cases, the third party may itself initiate the contact.

### Example 3.

In this example, the third party acts to introduce the researcher and the investigator site to each other.

1. The researcher contacts the third party, requesting samples of a particular type, or from subjects that meet a specified set of criteria.

2. The third party contacts investigator sites, and solicits the submission of samples, related personal information and sample information from subjects that meet the criteria specified by the researcher.

3. The third party, with the consent of the investigator site and the subjects, contacts the researcher. The researcher then prepares sample kits and CRFs, if desired.

4. The remainder of the procedure is then as for Example 1, step 1 et seq., above.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for anonymizing samples for use in research and development activities, the method comprising:
(a) collecting one or more samples from a subject by an investigator site;
(b) providing a sample to a researcher by the investigator site, wherein the sample is associated with a first code;
(c) providing personal information to a third party by the investigator site, wherein the personal information is sufficient to link the subject with the one or more samples; and
(d) providing a second code to the researcher by the third party.

2. The method of claim 1, wherein the method comprises the additional step of the destruction of the personal information.

3. The method of claim 1, wherein the samples are to be used in a longitudinal study.

4. A method for anonymizing samples for use in research and development activities, the method comprising:
(a) collecting from a subject by an investigator site:
(i) a sample; and
(ii) sample information;
(b) providing to a third party by the investigator site:
(i) the sample information of (a)(ii); and
(ii) personal information sufficient to link the subject of (a) with the sample of (a)(i) and the sample information of (a)(ii);
(c) providing the sample of (a)(i) to a researcher by the investigator site, wherein the sample is associated with a first code; and
(d) providing to the researcher by the third party the sample information of (a)(ii), wherein the sample information is associated with a second code.

5. The method of claim 4, further comprising the steps of:
(e) providing to the third party by the researcher:
(i) the first code; and
(ii) a request for one or more samples of the subject associated with the first code; and
(f) taking a sample from the subject by the third party, wherein the sample is associated with the first code of (e), and providing the sample to the researcher.

6. The method of claim 4, further comprising the steps of:
(e) providing to the third party by the researcher:
(i) the second code; and
(ii) a request for one or more samples of the subject associated with the second code; and
(f) taking a sample from the subject associated with the second code of (e), wherein the sample is taken by the third party and provided to the researcher.

7. A method for anonymizing samples for use in research and development activities, the method comprising:
(a) providing a request for a sample by a researcher to a third party;
(b) soliciting the sample from one or more investigator sites wherein the soliciting is done by the third party;
(c) collecting of a sample, sample information, and personal information by the investigator sites;
(d) submitting the sample, sample information and personal information by the investigator site to the third party, wherein the sample, sample information and personal information are coded with a first code;
(e) associating a second code with the sample, sample information and personal information, wherein the associating is done by the third party;
(f) submissing the sample and sample information to the researcher by the third party; and
(g) storing of the personal information by the third party.

8. The method of claim 7, wherein the first code is provided by the researcher.

9. The method of claim 7, wherein the first code is provided by the third party.
